(19) United States
(12) Patent Application Publication
(10) Pub. No.: US 2021/0053142 A1
(43) Pub. Date: Feb. 25, 2021

(54) EXPULSION SENSING METHOD AND EXPULSION SENSING DEVICE IN ELECTRIC RESISTANCE WELDING

(71) Applicant: MAZDA MOTOR CORPORATION, Hiroshima (JP)

(72) Inventors: Akira NAWAHARA, Aki-gun, Hiroshima (JP); Daisuke NAKAZAKI, Aki-gun, Hiroshima (JP)

(73) Assignee: MAZDA MOTOR CORPORATION, Hiroshima (JP)

(21) Appl. No.: 16/969,389

(22) PCT Filed: Feb. 7, 2019
(86) PCT No.: PCT/JP2019/004473

§ 371 Date: Oct. 21, 2020

(30) Foreign Application Priority Data
Feb. 16, 2018 (JP) 2018-025567

(51) Int. Cl. B23K 11/25; B23K 11/11

(52) U.S. Cl. CPC B23K 11/253; B23K 11/115

(57) ABSTRACT

An expulsion sensing device includes a spot welding device 2 that pressurizes, via a pair of electrodes 33 and 34, a workpiece W in which a plurality of metal plate members is superposed and welds the workpiece W by passing electricity between the pair of electrodes 33 and 34 while maintaining a predetermined pressurizing force, an operation control unit 42 that detects an interelectrode distance between the pair of electrodes 33 and 34 at predetermined time intervals, a calculation unit 51 that detects a temporal change rate of the detected interelectrode distance, and a determination circuit unit 52 that determines occurrence of expulsion when the detected change rate in an approaching direction of the pair of electrodes 33 and 34 is equal to or more than a predetermined threshold

### TECHNICAL FIELD

The present invention relates to an expulsion sensing method and an expulsion sensing device in electric resistance welding that clamp, with a predetermined pressurizing force, a workpiece in which a plurality of metal plate members is superposed via a pair of electrodes and weld the plurality of metal plate members by passing electricity between the pair of electrodes while maintaining the pressurizing force.

### BACKGROUND ART

Conventionally, an electric resistance welding device typified by spot welding is often used in a vehicle body assembly factory or the like. This spot welding device clamps a workpiece in which a plurality of metal plate members is superposed via a pair of electrodes and passes electricity between the pair of electrodes while maintaining a predetermined pressurizing force. The Joule heat generated by passing electricity between the electrodes melts the welded portion of the workpiece and generates nuggets, which are fused material of metal. After that, when electricity passing is stopped while the predetermined pressurization state is maintained, the nuggets are cooled and solidified and the workpiece including the plurality of metal plate members has been welded.

On the other hand, an increase in the current density of the welded portion excessively raises the temperature of the welded portion, thereby causing a phenomenon in which fused material of the welded portion scatters outside the workpiece, a so-called expulsion phenomenon. Since occurrence of an expulsion phenomenon makes the thickness of the welded portion thin due to scattering of fused material thin, the bonding strength is reduced and, if the scattered substance adheres to the outer surface of the workpiece, the painted surface may need to be corrected. Accordingly, there has been proposed a technique for suppressing in advance occurrence of an expulsion phenomenon in which fused material scatters.

The resistance welding device in PTL 1 has a pair of electrodes, a pressurizing device that applies a pressurizing force to the object to be welded from one of the electrodes, and an electricity passing device that passes a welding current between both electrodes and the resistance welding device performs welding by applying a pressurizing force and passing electricity to the object to be welded. This resistance welding device has a sensor for detecting the displacement amount of the electrodes and a current switching control device capable of switching the welding current based on the detected displacement amount and, when the detected displacement amount exceeds the threshold, this current switching control device switches the current value to a value higher than the welding current at that time.

### CITATION LIST

### Patent Literature

PTL 1: JP-A-2014-217854

### SUMMARY OF INVENTION

### Technical Problem

The resistance welding device in PTL 1 reduces occurrence of expulsion by increasing the welding current after increasing the contact area between the plate materials of the workpiece by melting the welded portion. However, if expulsion occurs in the welded portion due to some reason, it is necessary to detect the workpiece in which the expulsion has occurred from many workpieces that flow on the production line and correct the workpiece. In the resistance welding device in patent literature 1, although occurrence of expulsion is suppressed by adjusting the welding current, the identification of the workpiece on the production line in which expulsion has actually occurred still needs to rely on visual confirmation by the worker, thereby making it difficult to detect the workpiece in which the expulsion has occurred from many workpieces.

Focusing on the phenomenon in which the thickness of the welded portion becomes thin due to scattering of fused material, occurrence of an expulsion phenomenon can be detected based on the amount of change in the distance between the pair of electrodes. However, depending on welding conditions such as the plate thickness, the welding current value, and the pressurizing force of the workpiece or processing modes, the workpiece (welded portion) may be deeply crushed by the clamping operation via the pair of electrodes even if an expulsion phenomenon does not occur, and high detection accuracy may not be ensured by detection that is simply based on changes in the interelectrode distance.

An object of the present invention is to provide an expulsion sensing method, an expulsion sensing device, and the like in electric resistance welding that are capable of quantitatively detecting occurrence of an expulsion phenomenon regardless of welding conditions and the like.

### Solution to Problem

An expulsion sensing method in electric resistance welding according to claim 1 that pressurizes a workpiece in which a plurality of metal plate members is superposed via a pair of electrodes and welds the workpiece by passing electricity between the pair of electrodes while maintaining a predetermined pressurizing force, the expulsion sensing method including an interelectrode distance detection step of detecting an interelectrode distance that is a distance between the pair of electrodes at predetermined time intervals; a change rate detection step of detecting a temporal change rate of the detected interelectrode distance; and a determination step of determining occurrence of expulsion when the detected change rate in an approaching direction of the pair of electrodes is equal to or more than a predetermined threshold.

Since this expulsion sensing method in electric resistance welding has the interelectrode distance detection step of detecting the interelectrode distance at predetermined time intervals, the interelectrode distance can be detected chronologically. Since this method has the change rate detection step of detecting the temporal change rate of the detected interelectrode distance, the state change of the welded portion can be detected using the interelectrode distance as a parameter.

Furthermore, since this method has the determination step of determining occurrence of expulsion when the detected change rate in the approaching direction of the pair of electrodes is equal to or more than the predetermined threshold, the state in which the welded portion has been crushed by clamping operation via the electrodes can be distinguished from the state in which an expulsion phenomenon has occurred based on the change rate of the interelectrode distance and occurrence of an expulsion phenomenon can be detected quantitatively as a physical quantity.

In the invention of claim 2, the determination step determines the change rate of the interelectrode distance detected while electricity is passed in the invention of claim 1. In addition, the section to be excluded from the determination can be set even while electricity is passed in consideration of the effect of sensing error due to noise or the like.

This structure only needs to determine the change rate of the interelectrode distance in a limited period and enables the state change in the welded portion other than occurrence of an expulsion phenomenon to be eliminated while simplifying the processing.

In the invention of claim 3, the predetermined threshold in the determination step is 0.3 mm/sec in the invention of claim 1 or 2. It is also possible to set a threshold for each welding point and review the predetermined threshold itself so as to support new materials that do not meet the current predetermined threshold.

This structure can detect occurrence of an expulsion phenomenon quantitatively regardless of the plate thicknesses of the metal plate members.

In the invention of claim 4, the determination step determines that an expulsion phenomenon is severer as the detected changed rate is larger in the invention of any one of claims 1 to 3.

This structure can detect the magnitude of an expulsion phenomenon together with occurrence of the expulsion phenomenon.

In the invention of claim 5, the interelectrode distance detection step detects the interelectrode distance using a mechanism for driving a robot arm having, at an end thereof, a welding gun with the pair of electrodes in the invention of any one of claims 1 to 4.

This structure can simplify the equipment using an existing mechanism.

An expulsion sensing device in electric resistance welding according to claim 6 that pressurizes a workpiece in which a plurality of metal plate members is superposed via a pair of electrodes and welds the workpiece by passing electricity between the pair of electrodes while maintaining a predetermined pressurizing force, the expulsion sensing device including interelectrode distance detection means for detecting an interelectrode distance that is a distance between the plurality of electrodes at predetermined time intervals; change rate detection means for detecting a temporal change rate of the detected interelectrode distance; and determination means for determining occurrence of expulsion when the detected change rate in an approaching direction of the pair of electrodes is equal to or more than a predetermined threshold.

Since this expulsion sensing device in electric resistance welding has the interelectrode distance detection means for detecting the interelectrode distance at predetermined time intervals, the interelectrode distance can be detected chronologically. Since the expulsion sensing device has the change rate detection means for detecting the temporal change rate of the detected interelectrode distance, the state change of the welded portion can be detected using the interelectrode distance as a parameter.

Furthermore, since the expulsion sensing device has the determination means for determining occurrence of expulsion when the detected change rate in the approaching direction of the pair of electrodes is equal to or more than the predetermined threshold, the state in which the welded portion has been crushed by clamping operation via the electrodes can be distinguished from the state in which an expulsion phenomenon has occurred based on the change rate of the interelectrode distance and occurrence of an expulsion phenomenon can be detected quantitatively as a physical quantity.

In the invention of claim 7, the determination means determines the change rate of the interelectrode distance detected while electricity is passed in the invention of claim 6. In addition, the section to be excluded from the determination can be set even while electricity is passed in consideration of the effect of detection error due to noise or the like.

This structure can obtain basically the same effect as in claim 2.

In the invention of claim 8, the predetermined threshold for the determination means is 0.3 mm/sec in the invention of claim 6 or 7. It is also possible to set a threshold for each welding point and review the predetermined threshold itself so as to support new materials that do not meet the current predetermined threshold.

This structure can obtain basically the same effect as in claim 3.

In the invention of claim 9, the determination means determines that an expulsion phenomenon is severer as the detected changed rate is larger in the invention of any one of claims 6 to 8.

This structure can obtain basically the same effect as in claim 4.

In the invention of claim 10, the interelectrode distance detection means detects the interelectrode distance using a mechanism for driving a robot arm having, at an end thereof, a welding gun with the pair of electrodes in the invention of any one of claims 6 to 9.

This structure can obtain basically the same effect as in claim 5.

### Advantageous Effects of Invention

The expulsion sensing method and the expulsion sensing apparatus in electric resistance welding according to the present invention can quantitatively detect occurrence of an expulsion phenomenon regardless of welding conditions and the like.

### BRIEF DESCRIPTION OF DRAWINGS

FIG. 1 is an overall outline structural diagram illustrating an expulsion sensing device in spot welding according to example 1.

FIG. 2 is a schematic diagram illustrating a spot welding device.

FIG. 3 is an enlarged schematic view illustrating a welding gun in FIG. 2.

FIG. 4 is a graph illustrating the position and the change rate of an upper electrode when expulsion does not occur.

FIG. 5 is a graph illustrating the position and the change rate of the upper electrode when expulsion has occurred.

FIG. 6 is a graph illustrating the position and the change rate of the upper electrode when expulsion has occurred in two-thick plate welding.

FIG. 7 is a graph illustrating the position and the change rate of the upper electrode when expulsion has occurred in two-thin plate welding.

FIG. 8 is a graph illustrating the position and the change rate of the upper electrode when expulsion has occurred in three-thick plate welding.

FIG. 9 is a graph illustrating the position and the change rate of the upper electrode when expulsion has occurred in three-thin plate welding.

FIG. 10 is a graph illustrating the position and the change rate of the upper electrode when expulsion has occurred in other three-thick plate welding.

FIG. 11 is a flowchart illustrating the procedure of welding processing.

FIG. 12 is a flowchart illustrating the procedure of expulsion detection processing.

### DESCRIPTION OF EMBODIMENTS

An embodiment of the present invention will be described in detail below with reference to the drawings.

The following description assumes that the present invention is applied to an expulsion sensing device in spot welding and does not limit the present invention, applications thereof, or the use thereof.

In addition, the following description includes description of an expulsion sensing method in spot welding.

### EXAMPLE 1

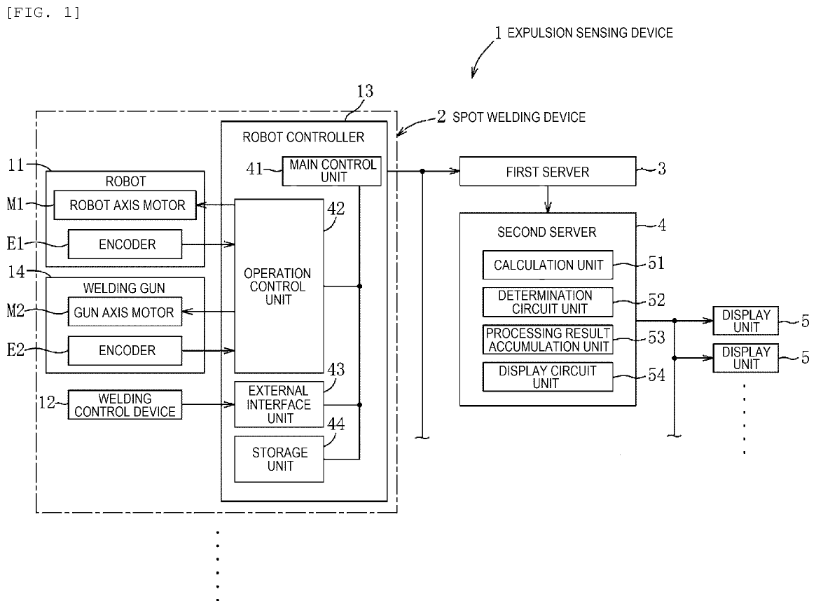

Example 1 of the present invention will be described below with reference to FIGS. 1 to 12.

As illustrated in FIG. 1, an expulsion sensing device 1 in electric resistance welding according to this example includes, as main components, a plurality of spot welding devices (electric resistance welding devices) 2 disposed along a production line, a first server 3 that receives data from the plurality of spot welding devices 2, a second server 4 that receives data from this first server 3, and a plurality of display units 5 that can display a determination result determined by this second server 4.

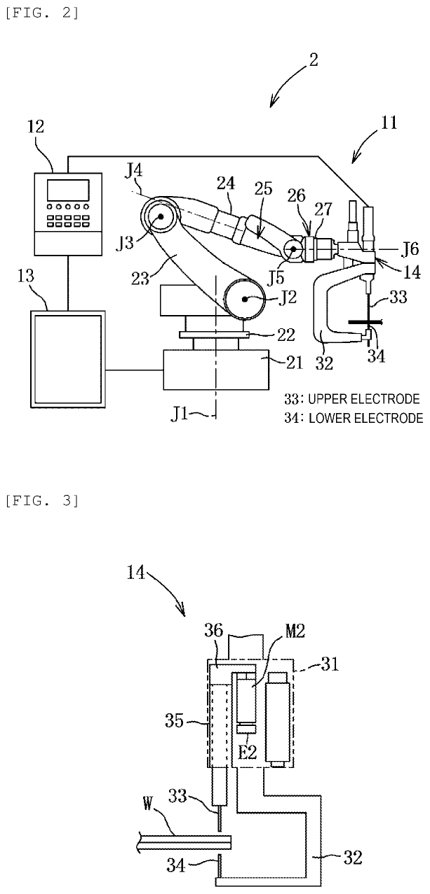

First, the plurality of spot welding devices 2 will be described. Any of the plurality of spot welding devices 2 have the same specifications and any of the spot welding devices 2 are connected electrically in parallel to the first server 3. As illustrated in FIG. 2, each of the spot welding devices 2 includes a spot welding robot (abbreviated below as a robot) 11, a welding control device 12, a robot controller 13, an electric spot welding gun (abbreviated below as a welding gun) 14, and the like.

The robot 11 is a multi-joint robot having six joint axes J1 to J6. This robot 11 includes a base 21, a swivel portion 22, a lower arm 23, an upper arm 24, a first end portion 25, a second end portion 26, an end flange portion 27, and the like and these components are mutually rotatable. The robot 11 has robot motors M1 (see FIG. 1) capable of driving individual members about the joint axes J1 to J6. Each of these robot motors M1 includes a servo motor and is controlled by the robot controller 13.

As illustrated in FIG. 1, an encoder El is attached to each of the robot motors M1 and the rotation amount and the rotation angle of the robot motor M1 are output to the robot controller 13. The welding gun 14 is attached to the end of the robot arm, which is a so-called end flange portion 27, and the position, the angle, the orientation, and the like of the welding gun 14 are controlled by the robot motors M1, which are controlled by the robot controller 13.

As illustrated in FIGS. 2 and 3, the welding gun 14 is configured by a C-type spot welding gun and includes a housing 31, a gun arm 32, an upper electrode 33 corresponding to a movable electrode, a lower electrode 34 corresponding to a fixed electrode, a gun motor M2, a ball screw mechanism 35, an encoder E2, a reducer 36, and the like. The gun motor M2 configured by a servo motor is controlled by the robot controller 13, and the rotation amount and the rotation angle are output to the robot controller 13 by the encoder E2. The ball screw mechanism 35 is a mechanism that includes a screw shaft and a nut and converts the rotational motion of the gun motor M2 via the reducer 36 into the linear motion of the upper electrode 33. The spot welding gun is not limited to a C-type spot welding gun, but may be an X-type spot welding gun or an O-type spot welding gun.

As illustrated in FIG. 1, the robot controller 13 includes a main control unit 41 that integrally controls individual component devices of the robot controller, an operation control unit 42 that controls the operation of the robot 11 and the welding gun 14, an external interface unit 43 that exchanges signals with, for example, a welding control device that controls the welding current value passing electricity between the electrodes 33 and 34, a storage unit 44 that includes a memory, and the like. The main control unit 41 calls a teaching program registered in advance and integrally controls individual component devices of the robot controller.

The operation control unit 42 controls the robot motors M1 and the gun motor M2 so as to move the welding gun 14 to the welded portion (welded point) of the workpiece W in which a plurality of metal plate members is superposed based on the detection values of the encoder E1 and the encoder E2. During welding, the operation control unit 42 controls the drive current of the gun motor M2 so that the pressurizing force to the workpiece W by the electrodes 33 and 34 equals the specified pressurizing force. Specifically, to set the pressurizing force to the workpiece W by the upper electrode 33 to the specified pressurizing force, a map in which pressurization command values corresponding to welding specifications (such as welded points and welding conditions) are associated with the current (torque) command values corresponding to these pressurization command values is preset by experiments or the like and the drive current is controlled by the current command value corresponding to the pressurization command value of the welded point that is the work target.

The external interface unit 43 is connected to the welding control device 12 and exchanges signals such as a welding condition number, a welding command, and welding completion. Based on the welding condition number, the welding command, and the like received from the robot controller 13, the welding control device 12 performs spot welding by passing electricity between the electrodes 33 and 34 in the state in which the welded portion of the workpiece W clamped with a specified pressurizing force by the upper electrode 33 and the lower electrode 34, and sends welding completion to the robot controller when electricity passing ends.

The storage unit 44 stores, at a predetermined time intervals (for example, 100 millisecond intervals), the interelectrode distance that is the distance between the electrodes 33 and 34 from the start of the pressurizing operation for grasping the welded portion of the workpiece W using the upper electrode 33 to the end of the welding processing of the welded portion. Specifically, the storage unit 44 stores the interelectrode distance from the start of pressurizing operation until the upper electrode 33 reaches the position at which the welding processing ends based on the detection value by the encoder E2 via the operation control unit 42.

Here, the operation control unit 42 corresponds to the interelectrode distance detection means for the electrodes 33 and 34.

Next, the first server 3 will be described.

The first server 3 receives all interelectrode distances of welding processing (welded portion) from the storage units 44 of the spot welding devices 2. It should be noted here that, to improve the efficiency of information processing, a collecting device (such as, for example, a collecting PC) that collects the interelectrode distances of all welding processing and converts the interelectrode distances into accumulation data may be provided between the plurality of spot welding devices 2 and the first server 3.

Next, the second server 4 will be described.

The second server 4 extracts the interelectrode distance of the welding processing selected based on a predetermined selection condition (for example, the production date) from the interelectrode distances of all welding processing accumulated in the first server 3, calculates the temporal change rate of the interelectrode distance of the extracted welding processing, determines whether expulsion has occurred, and accumulates the result. If the temporal change rate of the interelectrode distance can be obtained from the robot controller, this interelectrode distance may be collected and accumulated.

As illustrated in FIG. 1, the second server 4 has a calculation unit 51 (change rate detection means) as welding process grasping means, a determination circuit unit 52 (determination means), a processing result accumulation unit 53, and a display circuit unit 54, and the like.

The calculation unit 51 extracts the portion that is undergoing welding processing from the interelectrode distance of the welding processing input from the first server 3 and, based on this, calculates the change rate of the interelectrode distance, which is the so-called moving speed of the upper electrode 33 toward the lower electrode 34, and grasps the welding process.

The processing result accumulation unit 53 stores the calculation result of the calculation unit 51, the determine result of the determination circuit unit 52, and the like, and the display circuit unit 54 converts data such as the processing result accumulated in the processing result accumulation unit 53 into display data to be displayed on the display unit 5.

The determination circuit unit 52 determines whether an expulsion phenomenon has occurred using the change rate of the interelectrode distance during welding processing, which is the calculation result of the calculation unit 51, and a predetermined determination threshold.

Here, the behavior of the upper electrode 33 when an expulsion phenomenon does not occur will be described.

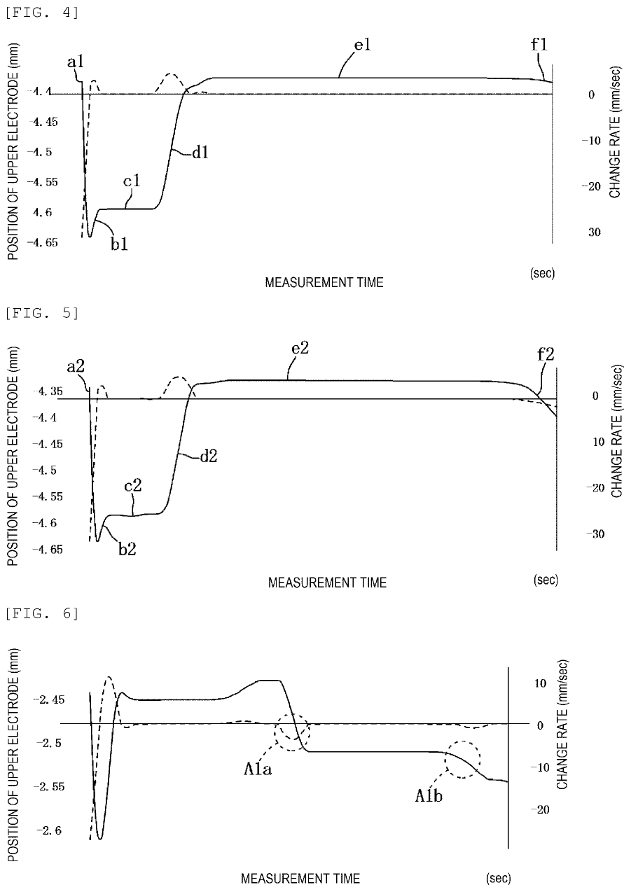

As illustrated in FIG. 4, in spot welding, the electrodes 33 and 34 start pressurizing operation of the workpiece W at time a1. After making a sudden descent, the upper electrode 33 makes a return ascent (pressurizing force overshoot) due to a control delay (time b1) and then is kept at the position at which the specified pressurizing force acts on the welded portion. When electricity is passed with the specified pressurizing force acting on the welded portion (time c1), the welded portion expands as the temperature of the welded portion rises and the upper electrode 33 makes an ascent (time d1). After that, the position of the upper electrode 33 becomes stable (time e1), a gentle descent is caused (time f1) by the collapse of the welded portion accompanying clamping operation after nugget formation, and then welding is completed.

In FIG. 4, the position (interelectrode distance) of the upper electrode 33 is represented by a solid line and the position change rate (speed) of the upper electrode 33 is represented by a broken line.

An expulsion phenomenon is a phenomenon in which the temperature of a welded portion rises excessively due to an increase in the current density in the welded portion and fused material of the welded portion scatters outside.

As illustrated in FIG. 5, when an expulsion phenomenon occurs, the behavior of the upper electrode 33 from time a2 to time e2 is substantially the same as the behavior from time al to time el when an expulsion phenomenon does not occur.

However, when an expulsion phenomenon occurs, since the fused material of the welded portion scatters outside instantaneously and the position of the upper electrode 33 makes a sudden descent. Accordingly, when the downward movement is positive, the position change rate of the upper electrode 33 at time f2 of this welding processing is 0.916 (mm/sec), which is significantly larger than the position change rate 0.153 (mm/sec) of the upper electrode 33 at time f1 when an expulsion phenomenon does not occur.

Since occurrence of an expulsion phenomenon can be detected mechanically without visual observation by determining the change rate of the interelectrode distance, the inventors found that a determination threshold of 0.3 (mm/sec) is appropriate for determining occurrence of an expulsion phenomenon when the movement toward the lower electrode 34 is positive.

Therefore, a verification experiment was performed for the above determination threshold.

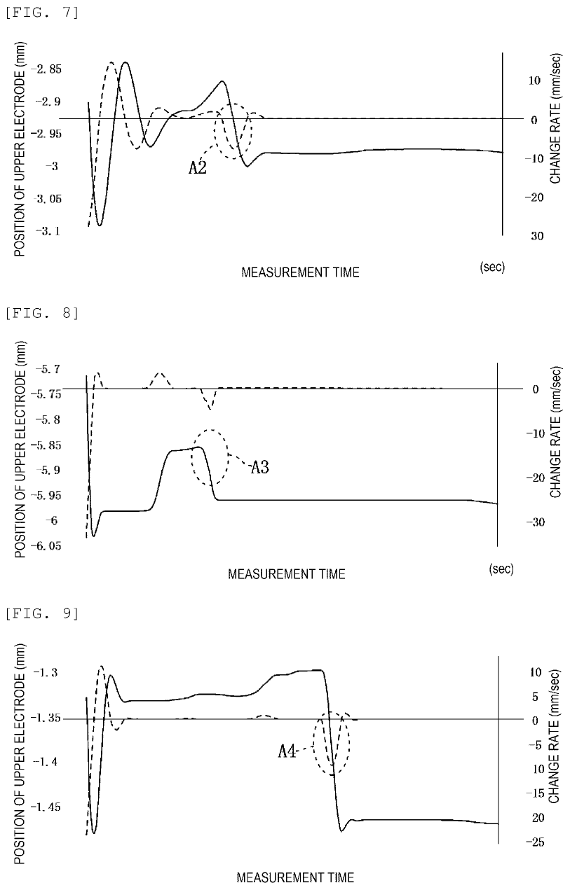

Hereinafter, individual verification experiments will be described with reference to FIGS. 6 to 10. In the figures, A1a to A4 indicate the times at which expulsion occurred.

FIG. 6 is a graph illustrating the position and the change rate of the upper electrode 33 when expulsion has occurred in two-thick plate welding for welding the workpiece W formed by 1.20 mm- and 0.60 mm-thick plates.

The position change rate of the upper electrode 33 when expulsion occurred at time A1a was 3.66 (mm/sec).

The position change rate of the upper electrode 33 when expulsion occurred at time A1b was 0.92 (mm/sec).

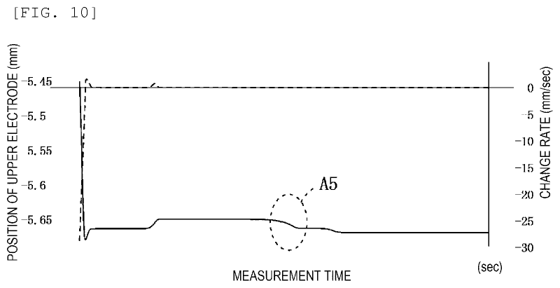

FIG. 7 is a graph illustrating the position and the change rate of the upper electrode 33 when expulsion has occurred in two-thin plate welding for welding the workpiece W formed by 0.60 mm- and 0.65 mm-thick plates.

The position change rate of the upper electrode 33 when expulsion occurred at time A2 was 7.78 (mm/sec).

FIG. 8 is a graph illustrating the position and the change rate of the upper electrode 33 when expulsion has occurred in three-thick plate welding for welding the workpiece W formed by 1.20 mm-, 1.40 mm-, and 1.60 mm-thick plates.

The position change rate of the upper electrode 33 when expulsion occurred at time A3 was 4.73 (mm/sec).

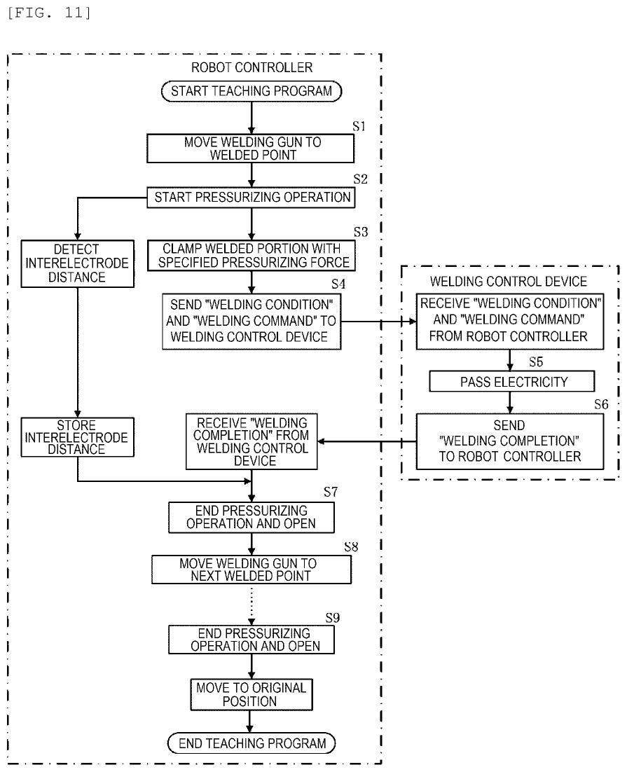

FIG. 9 is a graph illustrating the position and the change rate of the upper electrode 33 when expulsion has occurred in three-thin plate welding for welding the workpiece W formed by 0.65 mm-, 0.60 mm-, and 0.60 mm-thick plates.

The position change rate of the upper electrode 33 when expulsion occurred at time A4 was 9.61 (mm/sec).

FIG. 10 is a graph illustrating the position and the change rate of the upper electrode 33 when expulsion has occurred in three-thick plate welding for welding the workpiece W formed by 1.00 mm-, 1.20 mm-, and 1.00 mm-thick plates.

The position change rate of the upper electrode 33 when expulsion occurred at time A5 was 0.31 (mm/sec).

As a result of the above verification experiment, it was found that an expulsion phenomenon occurred regardless of the thicknesses or the number of plate members of the workpiece W when the position change rate of the upper electrode 33 after passing electricity was equal to or more than the determination threshold 0.3, and an expulsion phenomenon did not occur when the position change rate of the upper electrode 33 was less than the determination threshold 0.3.

The determination circuit unit 52 determines the welding processing (the welding processing in which an expulsion phenomenon occurred) in which the change rate of the interelectrode distance during welding processing, which is the calculation result of the calculation unit 51, is the determination threshold 0.3 or more after passing electricity and the welding processing (the welding processing in which an expulsion phenomenon did not occur) in which the change rate is less than the determination threshold 0.3.

In addition, it can be determined that an expulsion phenomenon is severer as the change rate of the interelectrode distance is larger.

The plurality of display units 5 includes existing PCs and the like and can receive the selection condition (such as, for example, the production date) for selecting the welding processing to be extracted from the first server 3 to the second server 4. In addition, this display unit 5 can display the processing result of the second server 4. Specifically, when the worker specifies a specific production line, date and time, and welding processing conditions (such as a robot number and a welding condition number), graphs (see FIGS. 4 to 10) illustrating the interelectrode distance and the change rate during the corresponding welding processing are displayed in a form in which the presence or absence of an expulsion phenomenon and the magnitude of an expulsion phenomenon can be identified.

Based on these types of information, the welding conditions in subsequent times can be reviewed. For example, a measure for reducing the welding current value may be taken if expulsion occurs in the first half of welding processing or a measure for shortening the electricity passing time can be taken if expulsion occurs in the second half of welding processing, so that excessive temperature rise can be avoided. In addition, information specific to the produced workpiece is also added to the processing result. This allows the worker to identify the workpiece W in which expulsion has occurred and to check the joint strength, check the appearance, and make correction.

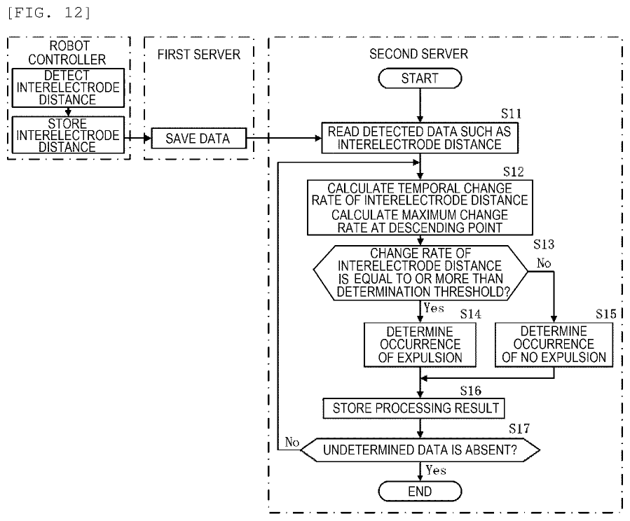

Next, the procedure of welding processing will be described based on the flowchart in FIG. 11.

It should be noted here that Si (i=1, 2, . . . ) represents the step for processing. The welding point, pressurization command value, welding condition number, and the like are registered in advance in the robot controller as a teaching program for each workpiece type and job. In addition, welding conditions such as the welding current and the electricity passing time are registered as a condition map in the welding control device for each welding condition number.

As illustrated in FIG. 11, in S1, the welding gun 14 is moved to the welding point of the workpiece W by driving the robot 11. In S2, a pressurizing operation for clamping the welded portion of the workpiece W between the electrodes 33 and 34 is started.

The upper electrode 33 is moved toward the lower electrode 34 by a pressurizing operation until the drive current (torque) of the gun motor M2 reaches the value corresponding to the pressurization command value, the welded point is clamped with a specified pressurizing force (S3), and then the welding condition number and the welding command are sent to the welding control device (S4). Based on the received signal, the welding control device reads the welding condition from the condition map and passes the welding current between the electrodes 33 and 34 (S5).

After passing electricity (including cooling), the welding control device sends a welding completion signal to the robot controller (S6).

The robot controller receives the welding completion signal, ends the pressurizing operation, and opens the welding gun (S7).

After that, the processing in S1 to the processing in S7 are repeated for the other welding points registered in the teaching program and the processing up to the end of the teaching program is executed (S8 and S9).

Next, the procedure of expulsion detection processing will be described based on the flowchart in FIG. 12.

The expulsion detection processing is executed via a startup operation by the worker or automatic startup by a PC or the like independently of the welding processing illustrated in FIG. 11.

As illustrated in FIG. 12, in S11, data such as the interelectrode distance, detected by the robot controller, that is selected according to the selection condition (for example, the production date) from the first server 3 is read.

Next, in S12, the temporal change rate of the interelectrode distance is calculated, the portion that is undergoing welding processing is extracted, the point (referred to below as the descending point) at which the upper electrode 33 makes a descent from the elevated position is extracted, and the maximum change rate of the interelectrode distance at the descending point is calculated.

The processing result in S12 is saved and used to determine occurrence of expulsion and display the processing result.

In S13, a determination is made as to whether the change rate calculated in S12 is equal to or more than the determination threshold (0.3 mm/sec). If the change rate is equal to or more than the determination threshold as a result of the determination in S13, occurrence of expulsion is determined (S14) and the processing proceeds to S16. If the change rate is less than the determination threshold as a result of the determination in S13, it is determined that expulsion does not occur (S15) and the processing proceeds to S16.

In S16, the number of welding executions for each of the welding processing conditions (for each of robot numbers and welding conditions) and the number of occurrences of an expulsion phenomenon that correspond to the selection conditions are stored and the processing proceeds to S17. In S17, it is determined whether undetermined data is not present. If undetermined data is absent as a result of the determination in S17, the processing ends. If undetermined data is present, the processing returns to S12 and continues determination.

Next, the operation and effect of the expulsion sensing device in the spot welding will be described.

Since the expulsion sensing device 1 according to example 1 has the operation control unit 42 that detects the interelectrode distance between the pair of electrodes and 34 at the predetermined time intervals, the interelectrode distance can be detected chronologically. Since the expulsion sensing device 1 has the calculation unit 51 that extracts the portion that is undergoing welding processing from the detected interelectrode distance and, based on this, calculates the maximum change rate of the interelectrode distance at the descending point, the state change of the welded portion can be detected using the interelectrode distance as a parameter.

Furthermore, since the expulsion sensing device 1 has the determination circuit unit 52 that determines occurrence of expulsion when the maximum change rate calculated by the calculation unit 51 is equal to or more than the predetermined threshold, the state in which the welded portion has been crushed by clamping operation via the electrodes 33 and 34 can be distinguished from the state in which an expulsion phenomenon has occurred based on the change rate of the interelectrode distance and occurrence of an expulsion phenomenon can be detected quantitatively as a physical quantity.

Since the determination circuit unit 52 determines the maximum change rate of the interelectrode distance at the descending point, the change rate of the interelectrode distance for a limited period only needs to be determined and the state change of the welded portion except occurrence of an expulsion phenomenon can be eliminated while the processing is simplified.

Since the determination threshold of the determination circuit unit 52 is 0.3 mm/sec, occurrence of an expulsion phenomenon can be detected quantitatively regardless of the plate thicknesses of the metal plate members or the like.

In addition, since it is determined that an expulsion phenomenon is severer as the detected change rate is larger, the magnitude of the expulsion phenomenon can be detected together with occurrence of the expulsion phenomenon.

Since the operation control unit 42 detects the interelectrode distance between the pair of electrodes 33 and 34 using the robot 11 having the welding gun 14 with the pair of electrodes 33 and 34 at the end thereof and a mechanism for driving the welding gun 14, the equipment can be simplified by using the existing encoder E2.

In addition, since this expulsion sensing method has the interelectrode distance detection step S11 of detecting the interelectrode distance between the pair of electrodes and 34 at predetermined time intervals, the interelectrode distance can be detected chronologically. Since the expulsion sensing method has the change rate detection step S12 of detecting the temporal change rate of the detected interelectrode distance, the state change of the welded portion can be detected using the interelectrode distance as a parameter.

Moreover, since the expulsion sensing method has the determination step S13 of determining occurrence of expulsion when the detected change rate in the approaching direction of the pair of electrodes 33 and 34 during the grasped welding processing is equal to or more than the predetermined threshold, the state in which the welded portion has been crushed by clamping operation via the electrodes 33 and 34 can be distinguished from the state in which an expulsion phenomenon has occurred based on the change rate of the interelectrode distance and occurrence of an expulsion phenomenon can be detected quantitatively as a physical quantity.

Next, modifications obtained by partially changing the embodiment will be described.
(1) Although an example of application to spot welding has been described in the embodiment, application to at least electric resistance welding is sufficient and application to, for example, projection welding is enabled.
(2) Although an example in which two servers including the first server and the second server are provided has been described in the above embodiment, these servers may be integrated into a single server depending on the capability of the server or may be subdivided into three or more servers.
(3) Other than the above, those skilled in the art can perform implement the present invention in a form in which various modifications are added to the embodiment or a form in which embodiments are combined with each other without departing from the spirit of the present invention and the present invention also includes such changed forms.

### REFERENCE SIGNS LIST

1: expulsion sensing device

2: spot welding device

33: upper electrode

34: lower electrode

42: operation control unit

51: calculation unit

52: determination circuit unit

E2: encoder

1. An expulsion sensing method in electric resistance welding that pressurizes a workpiece in which a plurality of metal plate members is superposed via a pair of electrodes and welds the workpiece by passing electricity between the pair of electrodes while maintaining a predetermined pressurizing force, the expulsion sensing method comprising:
an interelectrode distance detection step of detecting an interelectrode distance that is a distance between the pair of electrodes at predetermined time intervals;
a change rate detection step of detecting a temporal change rate of the detected interelectrode distance; and
a determination step of determining occurrence of expulsion when the detected change rate in an approaching direction of the pair of electrodes is equal to or more than a predetermined threshold.

2. The expulsion sensing method in electric resistance welding according to claim 1,
wherein the determination step determines the change rate of the interelectrode distance detected while electricity is passed.

3. The expulsion sensing method in electric resistance welding according to claim 1,
wherein the predetermined threshold in the determination step is 0.3 mm/sec.

4. The expulsion sensing method in electric resistance welding according to claim 1,
wherein the determination step determines that an expulsion phenomenon is severer as the detected changed rate is larger.

5. The expulsion sensing method in electric resistance welding according to claim 1,
wherein the interelectrode distance detection step detects the interelectrode distance using a mechanism for driving a robot arm having, at an end thereof, a welding gun with the pair of electrodes.

6. An expulsion sensing device in electric resistance welding that pressurizes a workpiece in which a plurality of metal plate members is superposed via a pair of electrodes and welds the workpiece by passing electricity between the pair of electrodes while maintaining a predetermined pressurizing force, the expulsion sensing device comprising:
interelectrode distance detection means for detecting an interelectrode distance that is a distance between the pair of electrodes at predetermined time intervals;
change rate detection means for detecting a temporal change rate of the detected interelectrode distance; and
determination means for determining occurrence of expulsion when the detected change rate in an approaching direction of the pair of electrodes is equal to or more than a predetermined threshold.

7. The expulsion sensing device in electric resistance welding according to claim 6,
wherein the determination means determines the change rate of the interelectrode distance detected while electricity is passed.

8. The expulsion sensing device in electric resistance welding according to claim 6,
wherein the predetermined threshold for the determination means is 0.3 mm/sec.

9. The expulsion sensing device in electric resistance welding according to claim 6,
wherein the determination means determines that an expulsion phenomenon is severer as the detected changed rate is larger.

10. The expulsion sensing device in electric resistance welding according to claim 6,
wherein the interelectrode distance detection means detects the interelectrode distance using a mechanism for driving a robot arm having, at an end thereof, a welding gun with the pair of electrodes.
